(19) United States
(12) Patent Application Publication
(10) Pub. No.: US 2015/0076770 A1
(43) Pub. Date: Mar. 19, 2015

(54) INSULATED HIGH TEMPERATURE COMPOSITE SEAL

(71) Applicant: EATON CORPORATION, CLEVELAND, OH (US)

(72) Inventors: Michael Sean Parker, Laurel, MD (US); Colin Presley Fleck, Glen Burnie, MD (US)

(73) Assignee: EATON CORPORATION, CLEVELAND, OH (US)

(21) Appl. No.: 14/031,614

(22) Filed: Sep. 19, 2013

(51) Int. Cl. F16J 15/06; F16J 15/08

(52) U.S. Cl. CPC F16J 15/064; F16J 15/0887
USPC 277/590

(57) ABSTRACT

An embodiment of the present disclosure includes a seal assembly. The seal assembly may include a metallic seal, an insulating sleeve, and a retaining clip configured to retain the insulating sleeve relative to the metallic seal. In an embodiment, a high temperature seal assembly may include a metallic seal, an insulating sleeve encompassing the metallic seal, a plurality of retaining clips configured to retain the insulating sleeve relative to the metallic seal, and first and second modified sealing surfaces, wherein the retaining clips are configured to provide the first and second sealing surfaces.

### TECHNICAL FIELD

The present disclosure relates to seals, including compression seals.

### BACKGROUND

Compression seals are widely used to provide a seal between two surfaces that may be configured to move, at least to a degree, relative to each other. Typically, such seals include a body portion comprising a metal material; although, the body portion may be configured with at least some elastic properties. In some situations, seals may be used to seal high temperature fluids. In high temperature applications, the high temperature fluid may be hot enough to cause the metallic body portion to lose its elastic properties, which may reduce the effectiveness of the seal.

### SUMMARY

An embodiment of the present disclosure includes a seal assembly. The seal assembly may include a metallic seal, an insulating sleeve, and a retaining clip configured to retain the insulating sleeve relative to the metallic seal.

In an embodiment, seal assembly may include a metallic seal, an insulating sleeve encompassing the metallic seal, a plurality of retaining clips configured to retain the insulating sleeve relative to the metallic seal, and first and second modified sealing surfaces, wherein the retaining clips are configured to provide the first and second sealing surfaces.

### BRIEF DESCRIPTION OF THE DRAWINGS

FIG. 1 is a cross-sectional view generally illustrating portions of a seal assembly in accordance with an embodiment of the present disclosure.

FIG. 2 is an enlarged partial cross-sectional view generally illustrating portions of a seal assembly in accordance with an embodiment of the present disclosure.

FIG. 3 is a cross-sectional view generally illustrating portions of a seal in accordance with an embodiment of the present disclosure.

FIG. 4 is an enlarged partial cross-sectional view generally illustrating portions of a seal assembly in accordance with an embodiment of the present disclosure.

FIG. 5 is a cross-sectional view generally illustrating a portion of a seal assembly in accordance with an embodiment of the present disclosure.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by appended claims.

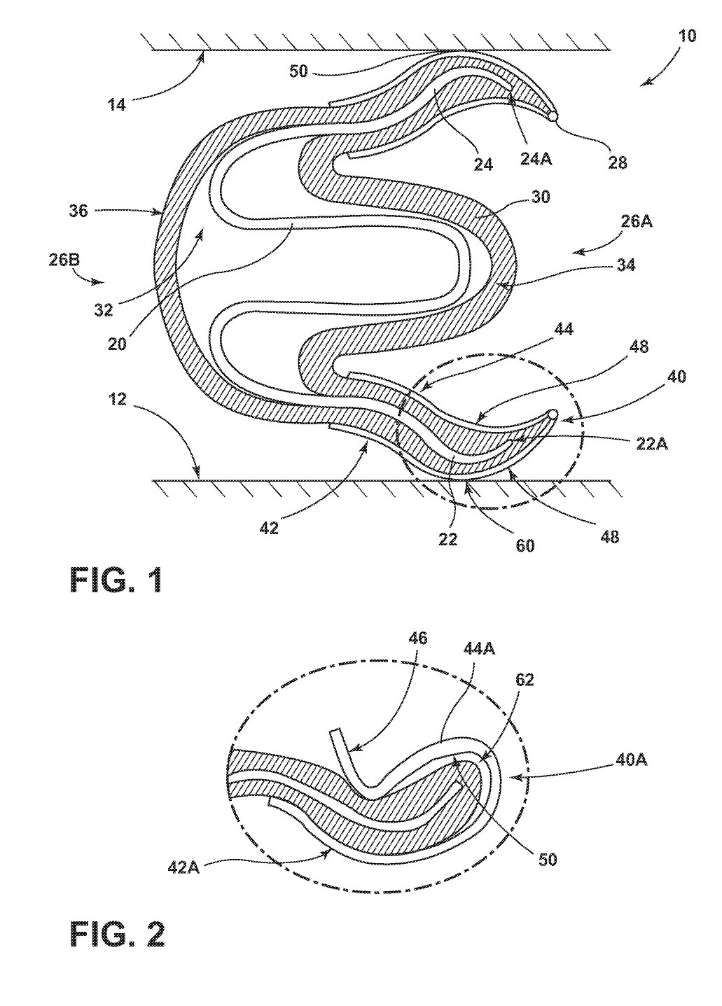

Referring to the drawings, FIG. 1 generally illustrates an embodiment of a seal assembly 10. Seal assembly 10 may include a seal 20, an insulating layer 30, and one or more retaining clips 40.

Seal assembly 10 may be configured to provide fluid sealing between two surfaces 12, 14. Surfaces 12, 14 may be part of single component or may be part of a plurality of components.

Seal 20 may comprise one or more of a variety of sizes, shapes, materials, and/or configurations. The shape of seal 20 may be configured to provide seal 20 with at least some elastic and/or pre-load characteristics. The elastic and/or pre-load characteristics may cause portions of seal 20 to be biased toward one or both of surfaces 12, 14, which may create a sealing relationship. For example, and without limitation, seal 20 may include a generally E-shaped seal. While seal 20 may be generally described herein as including a generally E-shaped seal, seal 20 is not so limited and may include other shapes, for example, seal 20 may include a v-shaped seal, a microplex seal, and/or a u-plex seal.

In embodiments, an seal 20 may include one or more legs, such as, for example, first leg 22 and second leg 24. In embodiments, first leg 22 may be configured to be biased toward first surface 12 and/or second leg 24 may be biased toward second surface 14.

In embodiments, seal 20 may include an insulating layer 30. Insulating layer may include ceramic, composite, and/or other materials. Insulating layer may be configured to at least partially thermally insulate seal 20. For example, insulating layer 30 may be arranged at a first side 26 of seal 20 to thermally insulate first 26. Insulating layer may be arranged around the entire exterior of seal 20, which may thermally insulate first and second sides 26A, 26B of seal 20.

Insulating layer 30 may reduce the temperatures to which seal 20 is exposed. Such reduced temperatures may help maintain the corrosion resistance of seal 20. Such reduced temperatures may also restrict the degree to which seal 20 may be susceptible to stress relaxation. Stress relaxation and corrosion resistance may lead to a failure because of loss of seal pre-load and/or a general material failure.

As generally illustrated in FIG. 1, insulating layer 30 may be arranged in contact with seal 20 in one or more locations. For example, insulating layer 30 may be arranged in contact with some or all of legs 22, 24 of seal 20. Additionally or alternatively, insulating layer 30 may be arranged at a distance from seal 20 in one or more areas (e.g., area 32). Insulating layer may include portions (e.g., portion 34) that are generally similar in shape to the shape of seal 20 and/or insulating layer 30 may include one or more portions (e.g., portion 36) that are not similar in shape to the shape of seal 20. Insulating layer 30 may extend generally outward from the ends 22A, 24A of legs 22, 24 and/or may include a greater thickness at and/or near the ends 22A, 24A of legs 22, 24.

As generally illustrated in FIGS. 1 and 2, seal may include one or more retaining clips 40. Retaining clips 40 may be configured to be arranged around and/or connected to seal 20. Retaining clips 40 may include first and second portions that may be provided at opposite sides of a leg of seal 10.

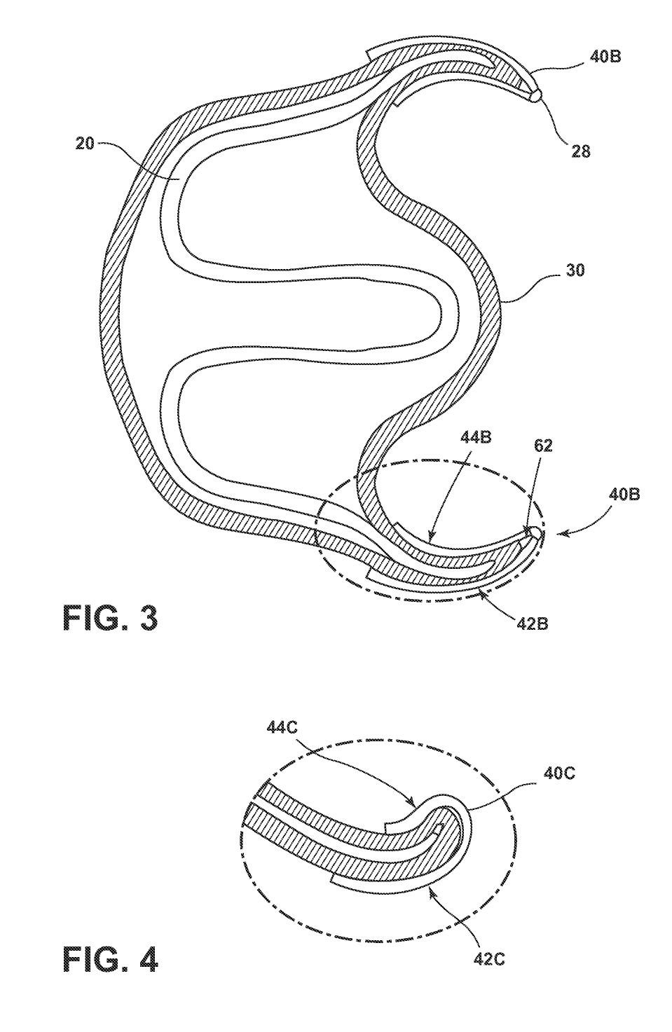

As generally illustrated in FIGS. 1 and 3, retaining clips 40 may be formed as a single unit including first 42 and second portions 44. For example, retaining clips 40 may be roll formed into a rounded clip that may be configured to fit over insulated legs of a seal.

In embodiments, as generally illustrated in FIGS. 2 and 4, retaining clips 40A may include separate first portions 42A, 42C and second portions 44A, 44C that may be connected together. First portions 42A, 42C and second portions 44A, 44C may be connected in one or more of several ways, including, for example, via a weldment 28. As generally illustrated in FIG. 2, retaining clips 40A may include a tab 46, which may be configured to facilitate manufacturing, assembly, installation, and/or removal of seal assembly 10. Tab 46 may provide strength and/or stiffness to retaining clips 40, which may help retain insulation layer 30 relative to seal 20.

First and second portions 42, 44 may include curved and/or angled portions 48 that may correspond with each other. Curved portions 48 may correspond with each other to retain insulating layer 30 relative to seal 20 (e.g., in a clip arrangement). In embodiments, retaining clips 40 may be the only means by which insulating layer 30 is retained relative to seal 20.

In embodiments, retaining clips 40 may be configured to be a continuous ring provided at a leg of seal 20. For example, second portions 44 may be configured as a continuous ring and/or first portions 42 may be configured as one or more tabs that may be folded and/or crimped over a leg of seal 20 to retain insulating layer 30 relative to seal 20.

In embodiments, retaining clips 40 may be configured to act as a modified sealing surface 60 for seal assembly 10. Modified sealing surface 60 may be configured to provide a more resilient seal surface than a sealing surface created only by insulating layer 30. For example, and without limitation, retaining clips 40 may include a high temperature super alloy, which may include nickel and or nickel-chromium super alloys such as Inconel 718® and/or Waspaloy®.

In embodiments, seal assembly 10 may include insulating layer 30 and/or retaining clips 40. Insulating layer 30 may reduce the temperatures that seal 20 is exposed to and retaining clips 40 may be configured around legs 22, 24 of seal 20 to act as modified sealing surfaces 60 to reduce potential wear of insulating layer 30 and to retain insulating layer 30 relative to seal 20.

As generally illustrated in FIG. 4, first portion 42C of retaining clip 40C may be shorter than second portion 44C of retaining clip 40C. Second portion 44C may be configured with a greater length to provide resilient sealing surface 60 with a greater surface area.

As generally illustrated in FIGS. 1 and 4, insulating layer 30 may be in contact with all or substantially all of an inner surface 50 of a retaining clip (e.g. retaining clips 40, 40C). In embodiments, insulating layer 30 may not be in contact with portions of the inner surface 50 of a retaining clip 40 and/or an air gap 62 may exist between insulating layer 30 and the retaining clips (e.g., retaining clips 40A, 40B).

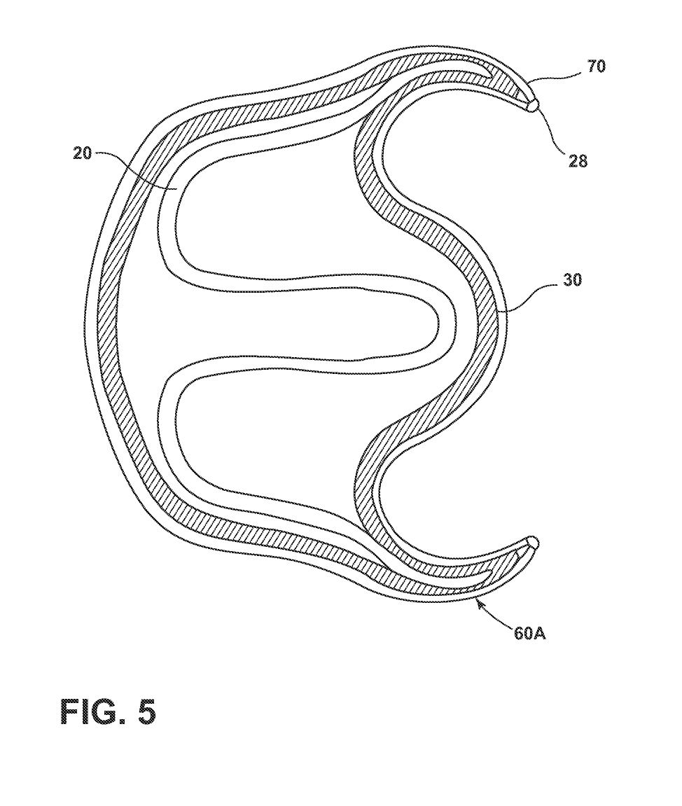

In embodiments, as generally illustrated in FIG. 5, seal assembly 10 may include a third layer 70, which may include a layer of foil arranged at and/or around a portion and/or all of insulating layer 30. Third layer 70 may be referred to herein as foil layer 70. Seal assembly 10 may include foil layer 70 in addition to or in place of retaining clips 40. If seal assembly 10 does not include retaining clips 40, foil layer 70 may be arranged between insulating layer 30 and surfaces 12, 14 and foil layer 70 may be configured to provide a resilient sealing surface 60A.

The foregoing descriptions of specific embodiments of the present disclosure have been presented for purposes of illustration and description. They are not indented to be exhaustive or to limit the invention to the precise forms disclosed, and various modifications and variations are possible in light of the above teaching. It should be understood that the present disclosure is not limited to the examples and/or embodiments described herein. For example, references to a single element are not so limited and may include one or more of such element. It is intended that the scope of the invention be defined by the claims appended hereto and their equivalents.

What is claimed is:

1. A seal, comprising:
a seal;
an insulating layer; and
a retaining clip configured to retain the insulating sleeve relative to the seal.

2. The seal of claim 1, wherein the retaining clip includes a first portion connected to a second portion.

3. The seal of claim 2, wherein the first and second portions are welded together.

4. The seal of claim 1, wherein the retaining clip is roll-formed.

5. The seal of claim 1, wherein the retaining clip includes curved portions.

6. The seal of claim 1, wherein the retaining clip comprises two retaining clips.

7. The seal of claim 2, wherein the first portion includes a length that is longer than a length of the second portion.

8. The seal of claim 1, wherein the insulating layer encompasses the seal.

9. The seal of claim 1, wherein the retaining clip is provided at least partially around a leg portion of the seal.

10. The seal of claim 2, wherein the first portion comprises a continuous ring and the second portion comprises one or more tabs.

11. A high temperature seal assembly, comprising:
a metallic seal;
an insulating sleeve encompassing the metallic seal;
a plurality of retaining clips configured to at least partially retain the insulating sleeve relative to the metallic seal; and
first and second modified sealing surfaces;
wherein the retaining clips are configured to provide the first and second modified sealing surfaces.

12. The high temperature seal assembly of claim 11, wherein each of the plurality of retaining clips includes two curved portions.

13. The high temperature seal assembly of claim 11, wherein the insulating sleeve is in contact with the metallic seal in at least one location and is not in contact with the metallic seal in at least one other location.

14. The high temperature seal assembly of claim 11, wherein the insulating sleeve includes a shape that is substantially similar to a shape of the metallic seal in at least some areas of insulating sleeve.

15. The high temperature seal assembly of claim 11, including an gap between the insulating sleeve and a portion of the plurality of retaining clips.

16. The high temperature seal assembly of claim 11, wherein the insulating sleeve is configured to at least partially maintain corrosion resistance of the metallic seal.

17. The high temperature seal assembly of claim 11, wherein the plurality of retaining clips are configured to reduce wear of the insulating sleeve.

18. The high temperature seal assembly of claim 11, wherein at least one of the retaining clips includes a first portion and a second portion, the first portion comprising a continuous ring and the second portion comprising one or more tabs.

19. The high temperature seal assembly of claim 18, wherein the tabs are configured to at least partially retain the insulating sleeve relative to the metallic seal.

20. The high temperature seal assembly of claim 11, wherein the plurality of retaining clips include a super alloy.
